(19) United States
(12) Patent Application Publication
(10) Pub. No.: US 2013/0309438 A1
(43) Pub. Date: Nov. 21, 2013

(54) TOPO-SLICE THERMOPLASTIC COMPOSITE COMPONENTS AND PRODUCTS

(71) Applicant: SMARTER PLANET LLC, San Francisco, CA (US)

(72) Inventors: Michael Robert O'Reilly, San Francisco, CA (US); Gregory William Pronko, San Francisco, CA (US); David Mayer de Rothschild, Buckinghamshire (GB); Frank P. Becking, Palo Alto, CA (US)

(73) Assignee: SMARTER PLANET LLC, San Francisco, CA (US)

(21) Appl. No.: 13/950,899

(22) Filed: Jul. 25, 2013

Related U.S. Application Data
(63) Continuation of application No. PCT/US2012/023031, filed on Jan. 27, 2012.
(60) Provisional application No. 61/437,492, filed on Jan. 28, 2011.

(51) Int. Cl. B32B 1/04; B32B 37/00; B32B 37/04

(52) U.S. Cl. CPC B32B 1/04; B32B 37/04; B32B 37/00
USPC 428/80; 264/258; 156/182

(57) ABSTRACT

Included herein are constructional techniques as well as finished goods produced thereby. The techniques described are especially useful in producing curved structures in topographical fashion with cutouts from sheets of thermoplastic composites material.

### CROSS-REFERENCE TO RELATED APPLICATIONS

This application is a continuation of International Application No. PCT/US2012/023031, filed Jan. 27, 2012, which claims priority to U.S. Provisional Application Ser. No. 61/437,492, filed Jan. 28, 2011, both of which are incorporated by reference herein in their entirety for all purposes.

### BACKGROUND

Self-reinforced thermoplastic composites have found utility in a variety of fields. Much of the previous innovation has focused on performance attributes, including the ability to shape, reshape and join the composite pieces. Some attention has been given to the material in terms of its potential for recycling and closed-loop “cradle-to-cradle” product cycles or systems.

The assignee hereof is in the business of implementing environmentally friendly solutions as its members successfully demonstrated on the Plastiki project. The Plastiki boat was built using a composite frame securing 12,000 two-liter bottles for buoyancy. The frame elements, together with the boat cabin, furniture, rudder and other structural features we built from srPET (self-reinforced polyester) material. Thus, if ever stripped of its rigging, the Plastiki can be fully recycled. It can be inserted into the PET recycling stream and fully utilized in any number of newly-minted consumer goods.

The building of the Plastiki and its voyage across the Pacific Ocean are well publicized. The vessel embodies a vision of recycled/recyclable product use. Through this vision, the public learned key messages of conservation.

Unexpected, however, was the public's keen interest in the underlying srPET technology upon which the craft was built. Government representatives, academic leaders, corporate chiefs and others voiced immediate interest in high-value structural goods produced with this recycled “high-tech” material. That interest represents a need which has not been met by others working in the thermoplastic composites field.

To be sure, many of the components produced according the to the present inventions can be (and have been) made otherwise. For example, a boat rudder or surf board fin can be contour-machined from a simple block of pre-consolidated layers of thermoplastic composite material. But the cost of a machining approach (in terms of time, wear-and-tear on equipment, material waste, etc.) is extraordinary in comparison to structures made according to the teachings herein. Also, parts produced according to the present inventions compare favorably to injection molded pieces in terms of cost and finish. However, they offer marked performance advantages.

### SUMMARY

The present inventions provide a cost effective solution for producing contoured thermoplastic composite goods—especially long fiber reinforced goods. So-produced, these goods offer tremendous market potential and the ability to source production without extreme sensitivity to labor cost. Unlike many existing composite industry production approaches, the subject approach is highly amenable to automation. Yet, the subject approach is still perfectly suitable for production in rural or under-developed locale.

The contours of the shaped goods made according to the present inventions are produced employing a topo-slice stacking approach. As with terrain features illustrated in a topographical map, the contours in the goods produced according to the inventions can vary in two dimensions across the height/depth of the article. Stated otherwise, the structures may be curved or contoured in two directions across the surface of the part perpendicular to a third direction (i.e., varying in shape in both in X and Y directions when progressing along a Z-axis as contrasted to an I-beam or structural C-shapes which have a consistent cross-section taken along the Z-axis).

In one aspect, cutout layers of fiber reinforced composite material including a thermoplastic polymer matrix are stacked upon one another. These layers may be fully flexible fabric layers. Or they may be stiffer partially or fully heat-bonded and consolidated (i.e., compressed under heat to remove air pockets/content) layers. As described below, certain advantageous mixed layering approaches are contemplated. Likewise, advantages are noted in connection with employing bonded/consolidated (at least in part) members alone.

The subject goods are advantageously produced using srPET composite material to facilitate recycling. High melt (a high tenacity/reinforcement fiber component) and lower melt (a matrix material component) portions of the srPET material are advantageously comingled with one another in tows of material woven into fabric. When heated to an appropriate temperature, the low-melt material flows to impregnate the solid-phase high-melt material. Upon cooling (in the case of srPET) a monomeric (and thus easily recyclable) composite material results. However, it is to be understood that the teachings herein are not limited to use of srPET, but generally applicable to other thermoplastic composite materials such as produced by Comfil, Inc. and others. Several examples of suitable thermoplastic composite materials offered by the noted vendor are presented in the table below:

| Reinforcement | Matrix | Weight % |
|---|---|---|
| Fibre | Fibre | Reinforcement |
| Glass | LPET | 57 |
| Glass | PET | 57 |
| Glass | PP | 60 |
| | Black | |
| Glass | PPS | 60 |
| Glass | LPET | 63 |
| Glass | LPET | 54 |
| Glass | LPET | 54 |
| Glass | LPET | 54 |
| Glass | LPET | 50 |
| Glass | LPET | 50 |
| Glass | LPET | 48 |

Other suitable materials to form layers of composite material utilized in the present inventions are described in any of U.S. Pat. Nos. 3,765,998; 4,414,266; 4,238,266; 4,240,857; 5,401,154; 6,828,016; 6,866,738 and US Publication Nos. 2001/0030017 and 2011/10076441 and others.

Regardless of material choice, according to one aspect of the present inventions, a stack of composite layer cutouts is set in a mold and heated to bond the layers together. With starting material that is fully bonded/consolidated, molding cycle times are reduced. It may be further reduced by using even lower melt temperature film adhesives on or between the pre-consolidated layers. Still, the layers may comprise un(heat) modified fabric incorporating matrix material or layers of fabric or matt together with some number (i.e., more or less in number) of flowable thermoplastic layers to provide the composite material matrix in the final composite layer(s).

Indeed, using pre-consolidate layers offers the additional advantage of eliminating distortion of fiber direction during molding. In essence, the “fixed” composite cloth does not deform/stretch, bunch, fold or kink the fibers. Also, the process effectively eliminates shrinkage issues commonly incurred when comingled or dry fiber tape thermoplastic hybrid fabrics are heated to thermoforming temperatures.

However configured, the stack can be setup in a mold such that material expansion upon heating provides the requisite internal pressure to produce a fully consolidated final part (i.e., a piece without significant air bubbles). Such a setup may simply involve clamping opposing mold pieces in a heated press, it may involve individually spring-loaded mold pieces set in an oven, or any other appropriate approach as commonly employed in bonding and consolidating thermoplastic composites (e.g., the so-called “trapped-rubber” approach in which a releasable silicone rubber layer provides pressured upon heating).

Additional optional aspects of the inventions concern the manner in which steps between the topo layer stack are smoothed to produce finished goods with a suitable surface finish. By “suitable” what is meant depends on the context. Namely, aerodynamic/fluid-flow and/or consumer grade finishes may require an extremely uniform and smooth finish.

Complex three-dimensional shapes are optionally produced in accordance with the present inventions. They are “complex” in two domains. One domain involves stacking pieces to define topographically varying layered structures. The other domain involves provision to smooth-out the topography. Namely, smooth surface net-shape pieces (or near net-shape pieces requiring minor/cosmetic surface finishing/machining) are formed in connection with a molding approach in which tuned mold gaps (and—optionally—relief ports) permit flow of the thermoplastic composite matrix material to fill or span transitions between the fabric layers and/or adhere edges. In other words, the relation between layered “slices” of material and the wall of a mold cavity are provided to enable matrix material flow to fill-in the steps of the stack as webbing. Likewise, the manner in which the slices (typically cutout sections of a larger composite material sheet) are stacked can have an impact on such material flow as illustrated below.

For the purpose of using the matrix material integrated in a comingled tow to produce the desired flow-fill and/or surface finish, a higher percentage (e.g., 50-60% or upwards) of matrix-to-structural fiber mix in the fabric employed may be desired in the composite material. Proportionally “doping” a comingled composite fabric in this manner provides for a desirable amount of matrix material to flow and fill and smooth the final shape. An entire part may be produced using such fabric. Alternatively, doped fabric (or comingled thermoplastic mat) may be set exclusively over stepped layers (where practical) as a functional veil or cap layer. Another capping approach involves using a matt or film of flowable matrix-type/like material only over stepped surfaces.

To conform to dramatic topographical variation, either the film, matt or fabric can be strategically cut, scored or relieved at sections to permit draping. For such purposes, the material is advantageously unbonded/unconsolidated so that it can conform to the underlying structure as best as possible. However, parts with limited or low convexity/concavity may employ stiffer capping members and rely on a complimentary mold surface to push the part into shape. Incorporating provision for vacuum in a mold element may alternatively, or additionally, be used in connection with such a matter or otherwise.

Yet, it will often be the case that the topographic layers are not overlaid by other material so that the steps formed between the layers directly face the mold surface. In some instances, the topography may simply not allow for material overlay without wrinkles or buckling in the material. In other instances, interference to polymer flow within a part by virtue of a topping layer or with reshaping perimeter fibers of the composite layer(s) will not be acceptable.

With specific reference to this last consideration of perimeter fiber manipulation, it may be desirable that the perimeter fibers in composite material are free to face, front or form the surface of the part. Particularly where a sharp, durable edge is desired in the final piece (or an intermediate product thereto) running reinforcement fiber all of the way to the edge of the structure where they can be splayed or flattened out against the surface of a mold cavity when heated to force matrix material flow (instead of being covered) can be desirable. Skateboards so-produced offer an example detailed below.

Interior features to the product may be incorporated as well—or in the alternative to the optional complexities described above. Specifically, product body coring and through-hole locating techniques are contemplated. As a variation of a location feature, screws or bolts may be used to make or pass through multiple aligned layers. Flow of matrix material around the fastener threads during heating then define female threading in the part. If/when the fastener is removed, the resulting threaded socket can serve as a convenient and durable attachment interface for supplemental hardware (such as skateboard trucks, hinges, other composite parts, etc.).

In another approach, threaded metal inserts are incorporated in the piece. These may be exposed at the surface or encased such that the surface of the part is drilled-out to open the socket. Alternatively, the member(s) encased in the finished part may only serve the purpose of leave-behind locating dowels/pins (such elements produced in foam, solid plastic or otherwise).

Layer separation techniques may also be employed. In one example, a stack of cutouts is laid-up with a non-bonding layer between opposing surfaces. PTFE may be used for this purpose. A living hinge between finished (or substantially finished) sub-section pieces can be constructed this way. Alternatively, an open pocket can be formed by air pressure expansion of an otherwise consolidated and bonded-together stack of material. Such an approach may be useful in the production of hot water solar panels. Likewise, channels may be incorporated (e.g., using straw elements or by preserving separated/separating sections to be opened by a secondary shaping procedure as per above) to fluidly couple various chambers together. Parallel and series arrangements are contemplated as are more complex possibilities.

As referenced above, in preparation for producing parts according to the present inventions, all of the desired shapes/sizes can be cut from pre-bonded/consolidated material. Using a CNC drag knife or other means to shape the pieces (such as stamping, water-jet cutting, etc.), kits of parts can be produced with minimal waste generated between parts arranged in complimentary or “nested” fashion. Utilizing material that is at least partially bonded is useful for handling. Utilizing fully bonded/consolidated material offers advantages in terms of heat transfer and minimizing cycle time.

In a sense, the complimentary cutout approach resemble a puzzle-piece pattern. More literally, it is contemplated that the cutout pieces may be configured assembly into larger layer sections utilizing a jigsaw fit technique—especially with fully or partially consolidated parent material.

In this regard, unique interfitting/interlocking shapes may be employed to ensure only one possible assembly configuration. The interlocking sections/portions of pieces may be capped or sandwiched between facing sections/portions. The interlocking members be interleafed with non-interlocking facing/capping layers. In any case, such features may assist in terms of design for assembly and/or in creating larger surfaces than the parent material from which the shapes are cut. The approach may also provide assistance in conforming to curved surfaces (e.g., in assembling a ball or globe) or another structure. In any case, the interfitting elements (optimally referred to as tongue & grove elements, lock & key elements or otherwise) are heated with the rest of the material (in a mold, press or vacuum bagged to a surface, etc.) to cause matrix polymer to flow and permanently lock the final shape of the product upon cooling.

Instead of arranging the cutout pattern in complimentary fashion during cutout and/or assembly, the pieces may instead be organized for side-by-side molding and connected by bridges of material for handling purposes, then stacked with other sequential slices in the mold. The bridges may be received by mold section gaps to allow for gang-molding multiple cavities at the same time. Such an approach maximizes production efficiency.

Even with such an approach (i.e., the bridge-connected cutout approach) waste can be eliminated in another manner. Specifically, the so-called “waste” from cutting out patterns to produce topographical part elements can itself be “engineered”. Uniform size chips or biscuits can be cut, punched or stamped from between the sections of the main-body material. These “engineered” leftovers are advantageously strong given their incorporation of long fiber reinforcement. They may be collected in a hopper and fed into a re-shaping process in which a three-dimensional body (such as by folding, bending or stamping) is produced. In one example, chip fill so-engineered is poured into a cavity within a part produced with topographical slices. When the part is heated to bond the layers together, the fill is sintered into an intermediate-weight coring material. A roofing shingle is advantageously so-produced. Alternatively, the material may be used as feed stock for extrusion or injection molding. In which case, the pieces may be sized in order to provide an ideal length to the long fiber reinforcement incorporated in the material. As such, it may serve as feed stock according to methods of producing Low Weight Reinforced Thermoplastic Composite (LWRT) as taught in co-pending provisional patent application entitled, “Low Weight Reinforced Thermoplastic Composite Goods” to the assignee hereof as filed on even date herewith and incorporated herein by reference in its entirety.

In all, it is to be understood that the innovations presented herein include a number of thermoplastic construction “tools” suitable for producing high-value self-reinforced composite structural goods (recreational and otherwise). These may be paired/utilized in connection with known techniques for handling such material. The present inventions also include the subject products, kits (for production, distribution, sale or otherwise) in which they are included and methods of manufacture and use. More detailed discussion is presented in connection with the figures below.

### BRIEF DESCRIPTION OF THE FIGURES

The figures provided herein may be diagrammatic and are not necessarily drawn to scale, with some components and features exaggerated for clarity. Variations of the inventions from the examples pictured are contemplated. Depiction of aspects and elements of the inventions in the figures are not intended to limit the scope of the inventions. However, the content of the figures may serve as the basis for claim limitations—as originally presented or as introduced by amendment.

FIG. 1 is a production process flowchart illustrating aspects of the inventions;

FIGS. 2A-2C show views of an exemplary construction approaches for a skateboard deck;

FIGS. 3A-3D show views of fin/skeg constructions also produced according to aspects of the inventions;

FIG. 4 illustrates a connected cutout approach with

FIG. 5 illustrating molding shingle components;

FIG. 6 illustrates a collection of finished shingles; and

FIGS. 7A and 7B show alternative puzzle-fit approaches for manufacture and final assembly, respectively in connection with the shingle example.

### DETAILED DESCRIPTION

As per above, the present inventions include constructional techniques as well as finished goods produced thereby. The techniques can be regarded as new “tools” that can be applied broadly across the composites fields, especially within the self-reinforced composite field. As such, various exemplary embodiments are described below. Reference is made to these examples in a non-limiting sense. They are provided to illustrate more broadly applicable aspects of the present inventions. Various changes may be made to the inventions described and equivalents may be substituted without departing from the true spirit and scope of the inventions. In addition, many modifications may be made to adapt a particular situation, material, composition of matter, process, process act(s) or step(s) to the objective(s), spirit or scope of the present inventions. All such modifications are intended to be within the scope of the claims made herein.

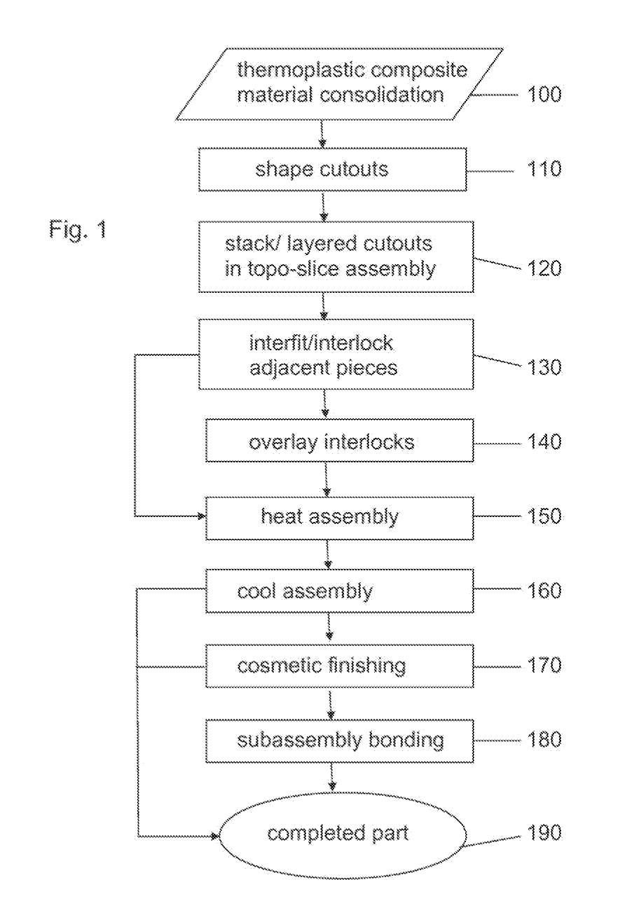

Turning to FIG. 1, a method of manufacture is illustrated. After procuring (or producing) partially or fully consolidated thermoplastic composite material at 100, cutouts from the material are shaped at 110, at least some of the cutouts having a curvilinear planform (top view) shape in at least one region and varying in size from one another. These are stacked or layered at 120 to define layers or strata making steps for an assembly. In doing so, certain ones (or all) of the pieces may be interfit or interlocked at 130. At least the interfitting sections may be capped or overlayed with pieces (e.g., matrix-only film or matt) at 140 to help fill-in any clearance gaps between the puzzle pieces and/or simply strengthen the bond.

In any case, the provision of cutouts and the layering of them is performed to yield final parts (i.e., products) different than the simple radius-filler and beam-type elements known in the art such as those in U.S. Pat. No. 6,709,538 and US Publication No. 2007/016559. These known shapes and associated approaches are consistent in shape along an axis during after molding. The method of products according to the present inventions are thus distinguished in each of their curvilinear cutout and final shapes, curved surfaces and such other feature as described herein.

However configured; the layers may be stacked on an assembly platen, table or platform and subsequently be vacuum bagged, run through a press, or assembled within a mold that is closed or set within a press, etc. At 150, the assembly is heated (typically under pressure, or with pressure caused by thermal expansion) to cause a matrix material in the thermoplastic composite material to flow and fill in the steps. As such, a webbing of a matrix material from the (optionally comingled) thermoplastic composite material forms a substantially uniform exterior surface between the layer perimeters.

Next, at 160 the assembly is cooled, allowing the matrix material to solidify and set a final shape. Such cooling may be actively accomplished, under ambient conditions or otherwise. A final product may receive further finishing at 170 such as trimming-off of solidified flow through mold gates, parting-off ganged pieces, etc.

Through the layering, the steps between the layers define a curved surface of the structure. The curvature may be defined in two different directions. Further, the opposite sides of the structure may both be curved, with opposite convexity. Optionally, no layer in the assembly to be heated or the final consolidated structure has a periphery substantially overhanging another relative to a facing surface of a mold cavity in which it is set and heated, and the flow filled steps produce a uniform surface exposed as an exterior surface of the final structure upon mold cavity removal. Alternatively, the flow filled steps may define a substantially planar surface in the finished part. In any case, the finally shaped part may be bonded to a similar or identical part (as in two sub-assembly halves of a structure) at 180 to produce a final part at 190.

During manufacture, coring material (e.g., structural foam, honeycomb, LWRT, etc.), locator pins, mold bosses, etc. may be received by the layers (e.g., during layering 110) per variations described below, or otherwise. Other variations to the methods as may subsequently be claimed will also be apparent given the structure of the exemplary embodiments described in detail below.

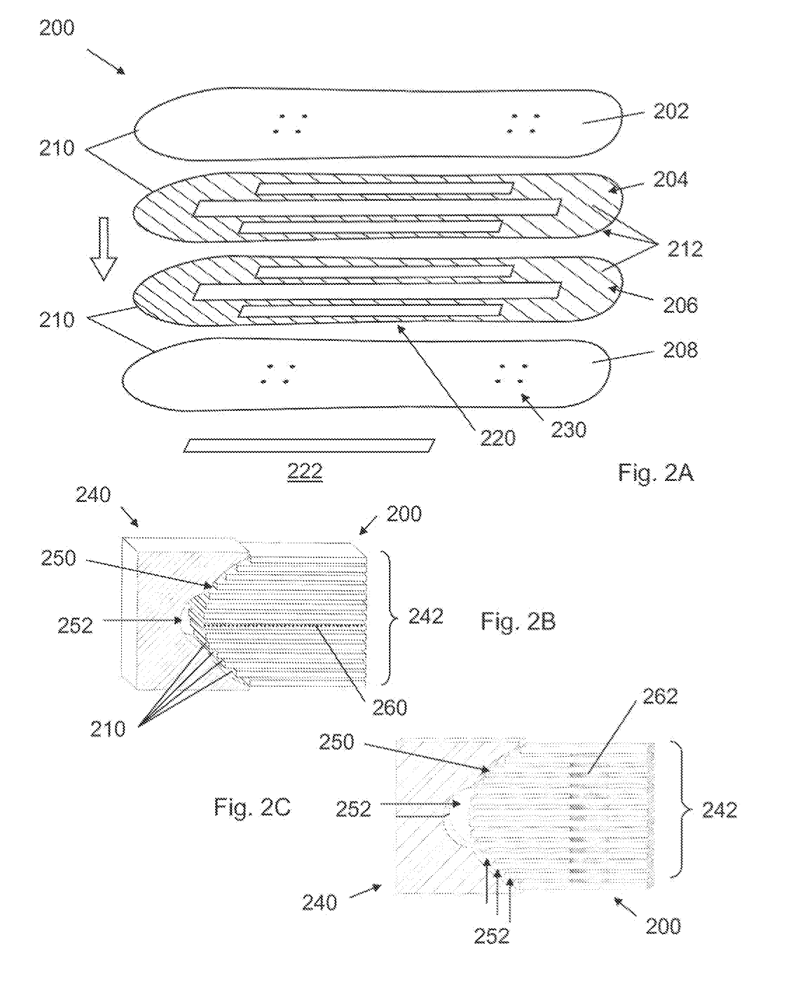

In a first product example, FIGS. 2A-2C illustrate a skateboard deck 200 formed from slices 202, 204, 206, 208 with different outer peripheries/extents 210 to defined curved edges in a final piece without resort to routing or other mechanical post-processing (except perhaps, for cosmetic finishing). Certain of the interior slices 204, 206 (individually stacked or pre-laminated) may be further cutout. The interior cutouts 220 optionally receive coring elements 222 (e.g., structural polymer foam, honeycomb, foamed metal, etc.). When bonded together, the upper and lower outer slices 202, 208 form the skin of the newly-formed composite panel with intermediate slices 204, 206 for outermost edges.

When the cut-out interior slices are independently stacked upon one another (as opposed to being included in a pre-laminated structure), the core pieces offer assistance for alignment thereof. For this purpose, the members may be sized to offer a close-fit or light press-fit relationship. The strategic use of cavities left open for the insertion of core elements are also potentially useful for weight reduction, tuning flexural characteristics and for vibration absorption.

Pre-punched or milled holes 230 where through-hole bolt patterns may be desired in the final part to enable rapid and simplified alignment of the various layers with pins through the mold. Further assisting assembly, the use of multiple thin layers of composite material enables bowing and/or slippage between the elements as they are stacked into a contoured mold cavity.

As further illustrated in FIG. 2A, cutout and (at least partially) pre-consolidated sheets of composite material (or subassembly stacks thereof) 202-208 may be laminated on either or both sides with a film 212 that melts at a lower temperature than the matrix material in the sheet. This can enhance interlaminar bonding at thermoforming temperatures and facilitates boding at lower temperature for quicker processing. In the case of hybrid or monopolymer thermoplastic fiber reinforcement layers, this lower temp film adhesive provides bonding at thermoforming temperatures below the matrix melt point so as not to compromise the fiber matrix integrity.

In certain cases, additional (i.e., more than strictly necessary) optional layer(s) of composite are used and stacked into a mold to develop higher pressures as the matrix is squeezed out of the pre-consolidated panels at thermoplastic flow temperatures. Alternatively, a “trapped rubber” element (e.g., a silicone rubber pad—shaped to fit within the mold cavity and defining a wall thereof) can be employed to expand as it heats and provide the pressure. Such an element may advantageously include a texture features to integrally mold “grip tape” (or other) features into the surface of the part such as functional and/or cosmetic texturing to a shingle so-produced.

FIGS. 2B and 2C provide section illustrations of mold cavities and layers of material to illustrate various such options. In each, a mold section 240 is shown. Multiple thermoplastic composite layers 242 are shown as well. The mold section (split in the case illustrated in FIG. 2C) shows a tuned gap or cavity 250 that surrounds the thermoplastic composite layers. The gap in a reservoir section 252 is able to accept excess matrix material flow from (or direct flow out of gates in the mold) or lower temperature thermoplastic material layered-in or bonded layers material flowing out from between the composite layers 242 upon application of heat and pressure.

Except for such areas to be trimmed off in a finishing step, the molded part is otherwise net shaped upon exit from the mold. This result can advantageously be accomplished with the need to profile cut the sheets of composite material. Rather, steps 256 between layers (as shown in either of FIG. 2B or 2C) are filled-in with matrix material flowing to smooth the curve of the profile. Such action may be facilitated (as described above) by the incorporation of matrix-specific layers in the composite stack, or alternatively by incorporating a higher percentage of matrix polymer fibers in a composite fabric (e.g., as compared to the Comfil composite formulations noted above). The extra available flow of this resin then acts somewhat like an injection molding operation as if flow and fills the contours to the mold cavity.

FIG. 2B illustrates the inclusion of such a specialty layer 260 in the stack. This element may be a slice in the stack that includes extra matrix material or it may be composed entirely from matrix material to provide additional material to flow into the tuned mold cavity gap(s).

In another variation, the specialty layer may be a slice in the stack that serves as a release ply (e.g., comprising PTFE). It may go to the edge of the fiber reinforced layers or terminate inboard of them. In the former case, matrix material filling an adjacent mold cavity section 252 can leave a bead along the finished part to serve as a living hinge. In the latter case, the release ply may facilitate separation of the layers along to ply for a reforming step to expand the part and form a bladder. In yet another variation, the specialty layer is a dissolvable member to provide for (ultimate) layer separation. Various water soluble or chemical-solvent dissolvable foams or substrates may alternatively be employed. Still further, the specialty layer may be a layer of silicone rubber to facilitate producing molding pressure.

Another option aspect concerns part alignment utilizing insert pins or dowels internal to the part as illustrated in FIG. 2C. Here, permanent pinning elements 262 are sealed within the composite body 200 being manufactured. These encased members may comprise foam, wood or the same polymer (e.g., PET) from which the composite body is produced. As shown, their length may be tailored so that they do not penetrate the top or bottom skins 244 of the finished part, thereby enhancing part integrity and surface quality.

More generally, FIGS. 2A-2C illustrate the curvature that may be achieved employing the subject topo-slice construction approach. The planform/planview shape of each layer (or an assembly of layers) of cutouts from a larger composite sheet varies in two directions to define bi-directional curvature of the final part. Irrespective of the coordinate system employed, the peripheral shape of each piece varies in some section from a straight line as seen in FIG. 2A. Likewise, as seen in FIGS. 2B and 2C in cross section, the individual layer slices vary in extent to define a rounded edge or rail upon filling in the steps formed between the slices.

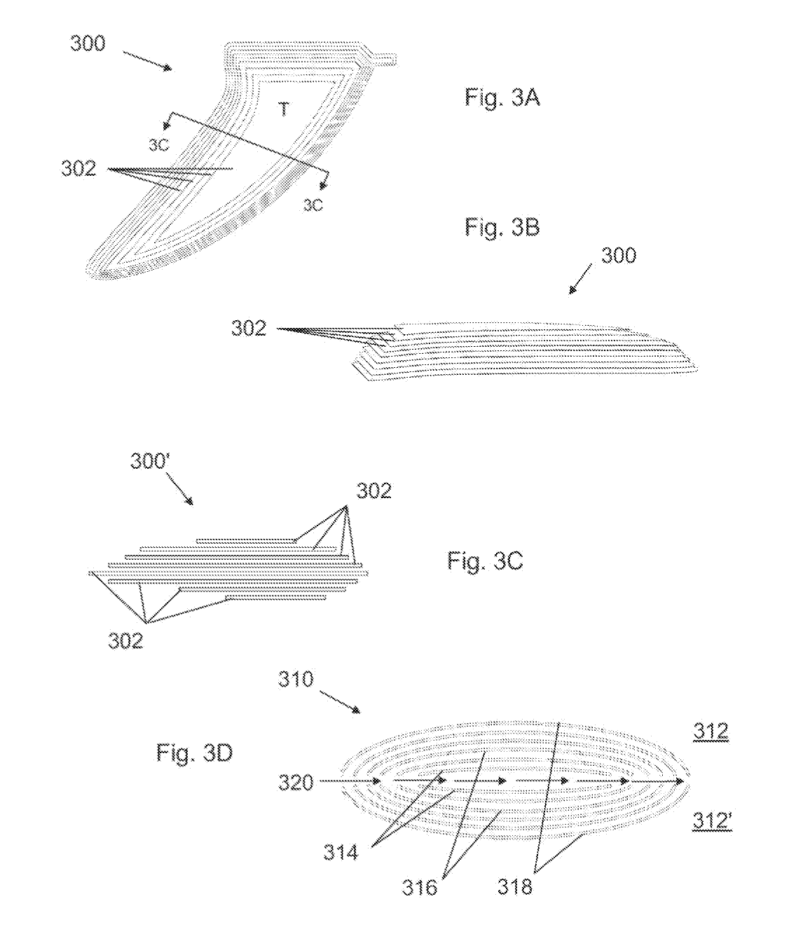

Reference to FIGS. 3A-3D illustrates another example of topo-slice derived products with bi-directional curvature across the surface of the subject parts. Specifically, various surfboard (or other aquatic sport board) fin/skeg construction views are shown.

FIG. 3A offers a plan view of a fin 300 comprising a plurality of layers 302 stacked in topographical fashion. In an assembly view 3B, the layers illustrate the contoured elevation that can be achieved on the exterior surface of the composite body being produced. In FIG. 3B, the fin is to be molded substantially flat on its broadest side. However, FIG. 3C illustrates an approach in which different curvatures are built-up on each side of the fin 300. While only shown in cross-section in FIG. 3C (e.g., along line 3C-3C shown in FIG. 3A, it can be readily appreciated that the curvature attained can vary in across the whole surface of each of the front and back of the fin (namely, as illustrated on the top side “T” shown in topographical relief in FIG. 3A.

FIG. 3D contemplates another construction approach. Specifically, a two-part fin 310 (prior to bonding two halves 312, 312′ produced in identical fashion) together is shown. As an alternative, all of the pieces illustrated in FIG. 3D can be laid-up in a mold and bonded simultaneously.

In any case, it can be observed that the smaller layers 314 are set in what will be the interior of the part. They are, thus, hidden in a sense “underneath” relatively larger outer layers 316. Regardless, their different varying extent produces the curved exterior shape in each subcomponent 312/312′.

Essentially, a comparison of the approaches shown in each of FIGS. 3C and 3D can be regarded as illustrative of “inside out” vs. “outside-in” construction approaches to defining the curvature in the parts. However, each uses a topo-slice approach. In the former case (i.e., as shown in FIG. 3C), the larger pieces are set to the interior and the smaller ones layered on the outside to define the curvature. In the latter case (i.e., as shown in FIG. 3D), the smaller pieces are set to the interior and larger ones layered on the outside. Of course, the outer layers in the latter case must deform. Accordingly, in such an approach it may be advantageous to strategically cut, relieve or score at least the outermost layer(s) 318 in patterns to assist with draping, or to use non-woven matt so that no organized fibers prohibit surface conformance for such purposes.

In the case of the embodiments pictured in any of FIGS. 2A-3C in a fully consolidated part, matrix material will be concentrated on the outer surface spanning the fiber-reinforced steps defining the layer-to-layer curves. In the case illustrated in FIG. 3D, such concentration will be along the flats 320 which may assist in element bonding. Also regarding the approach shown in FIG. 3D, it may be advantageous for wear and other considerations that the exterior surface of the part comprise uninterrupted composite fabric. Naturally, the approaches may also be combined. In one example, one or more facing layers (fiber-reinforced or not) are added to cover a construction as shown in FIGS. 3A-3C.

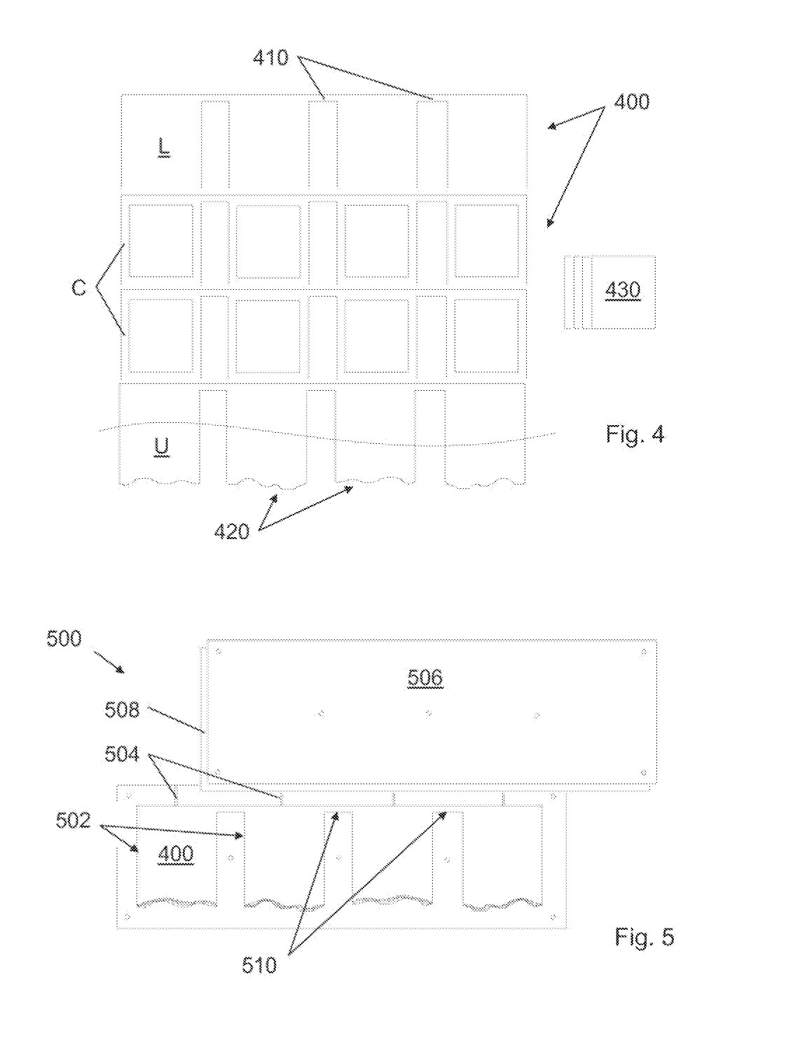

FIG. 4 illustrates a connected cutout approach in which cutouts 400 are held together by bridges/connectors 410. In this case, the pieces are for roofing shingles. Four layers (partially overlapping) of cutouts are shown. They vary in their proximal extent 420 to provide a custom-curved appearance that may resemble slate (for which purpose the edge is exaggerated as the shingles will typically be viewed from afar) or wood shingle material. Central slices “C” include bordered pockets for receiving core material 430 as optionally described above.

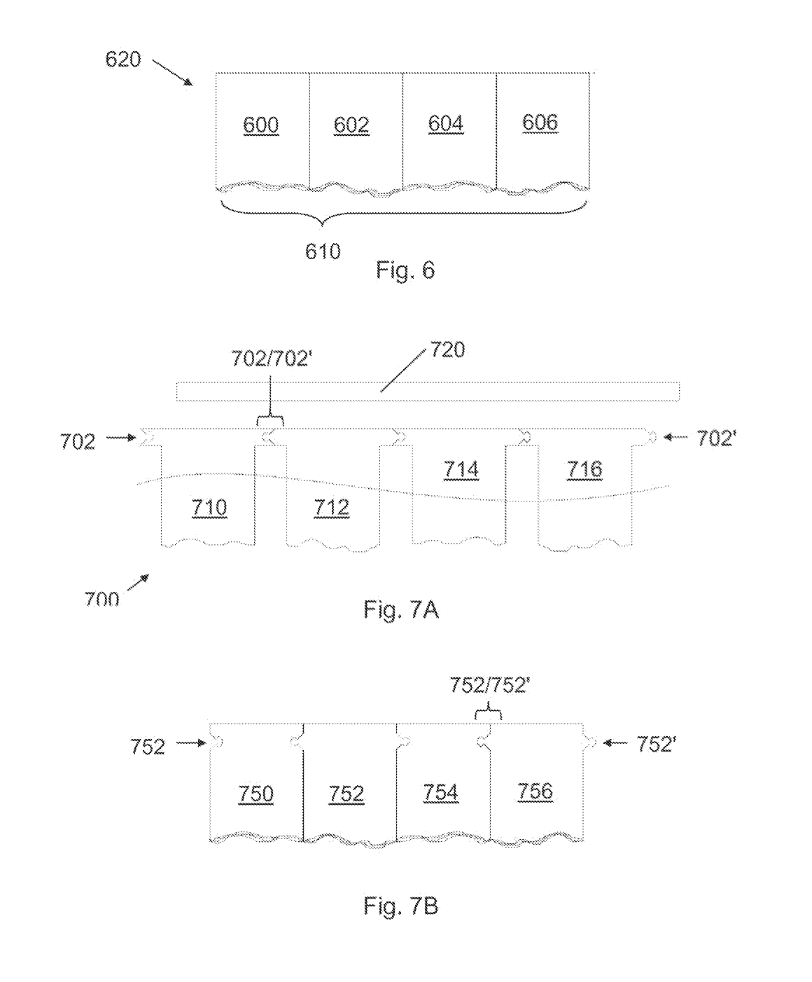

Notably, at least the uppermost slice in the stack “U” (see final pieces illustrated in FIG. 6) may comprise LWRT material and thus be particularly suitable for taking on a surface texture. Conversely, at least the lowermost slice in the stack “L” may advantageously comprise full-fabric fiber reinforced thermoplastic material to provide additional strength/toughness to the part(s). Also, it is noted (as indicated by the section line in the drawing) that the shingles may vary in length and/or aspect ratio.

In any case, cutouts 400 are shown fully overlapped within mold 500, set within multiple mold cavities 502. As shown, the proximal extent display topographical contours. The extent of these can be varied to incorporate any more of the shingle intended to be shown on a completed roof. As such, capping shingles may be surrounded by visually appealing features.

In any case, mold 500 includes connector gates 504 to permit outflow of excess matrix material. A top or cover 506 to the mold may be bolted-on, or alignment pins may be provided in guide holes 508. Optional connector section 510 between the mold cavities accommodate bridges 410. A textured and/or contoured silicone pad 520 may also be secured within the mold (or press) elements. Such a pad may be to provide pressure upon heat expansion, a pattern for surface texturing or both.

FIG. 6 illustrates a collection of unique finished shingles 600-606. Such a collection may be produced separately, or in a gang production method—optionally as described above in connection with FIGS. 4 and 5 after which bridge sections are trimmed off.

The proximal extent 610 of the coordinated set 620 of shingles is pictured as a series of complex curves by topographical lines depicting a natural or “enhanced” shape. The sculptural graphics (i.e., complex curvature) between each separate/separable unit is coordinated with the other to be visually attractive and avoid jumps or discontinuities that interfere with the visual and physical operation of the system. Namely, squared/sharp/discontinuous edges are avoided, thus reducing pockets for water stagnation and fungus growth, catching clothing, etc. when treading on the roof, etc. The shingles may be individual/separable, or variously bonded together in a lot as shown.

As for such association of shingles or other elements with one another for manufacture or for final assembly, FIGS. 7A and 7B show alternative puzzle-fit approaches that may be employed and/or further adapted within the scope of the present inventions.

In FIG. 7A, one of various shingle assembly slices 700 is shown. However, instead of cutting the material with connection bridges as seen with slice 400 from a large sheet, various subcomponents 710-716 may be cutout and assembled to form the larger panel. Such an approach may be desirable when a greater number of individual dies are desired for processing the material, or when the so-called cutouts are produced from injection molded material (such as in LWRT stock) limited in size. As such, reference to “cutouts” above is applicable in this broader sense. Thus, the parts may be formed, shaped (e.g., net-shape injection molded, stamped, blow-molded, roto-molded, vacu-formed, etc.), or otherwise provided as cutouts. In any case, with the so-called cutout shapes, the puzzle pieces may be fit together to form a large body for gang molding as referenced above.

Unique interfitting/interlocking shapes and/or orientations may be employed to ensure only one possible assembly configuration as shown. The interfitting/interlocking elements 702/702′ may be overlaid (or trapped between two) facing member(s) 720 to secure the puzzle lock for ease of handling upon selective application of heat to flow and bond matrix material (e.g., through ultrasonic welding, etc.). Similar layers may be stacked in a mold to complete a final part or series of parts to subsequently be separated. The interlocking members be interleafed with non-interlocking facing/capping layers or similarly-constructed puzzle-piece members where the interfitting elements are staggered/unaligned.

In any case, the features may assist in terms of design for assembly and/or in creating larger surfaces than the parent material from which the shapes are formed/cut. The approach may also provide assistance in conforming to curved surfaces (e.g., in assembling a ball or globe) or another structure. In any case, with panels 700 constructed as shown in FIG. 7A, the interfitting elements (optimally referred to as tongue & groove elements, lock & key elements or otherwise) are heated with the rest of the material (in a mold, press or vacuum bagged to a surface, etc.) to cause matrix polymer to flow and permanently lock the final shape of the product upon cooling.

In FIG. 7B a related interlocking approach is shown for completed (i.e., post-molded) shingle elements 750-756 ready for building installation. Similar to the above, different puzzle-piece sections 752/752′ ensure assembly in the desired order. As well as offering convenience, such interlinking of components can also dramatically improve final unit strength and safety walking on a finished roof as single shingles are further secured from slipping out of place. Any extra/unneeded puzzle-piece sections 752 can be trimmed off from the ends with shears or other means typically available to the artisan installing the product.

### VARIATIONS

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and the include plural referents unless specifically stated otherwise. In other words, use of the articles allow for at least one of the subject item in the description above as well as the claims below. Likewise, a matter described as “substantially” having some quality includes the possibility that it fully or completely possesses that quality. It is further noted that the claims may be drafted to exclude any optional element. As such, this statement is intended to serve as antecedent basis for use of such exclusive terminology as “solely,” “only,” “alone” and the like in connection with the recitation of claim elements, or use of any type of “negative” claim limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the present inventions are not to be limited to the examples provided and/or the subject specification, but rather only by the scope of the claim language. Use of the term “invention” herein is not intended to limit the scope of the claims in any manner. Rather it should be recognized that the “invention” includes the many variations explicitly and implicitly described herein, including those variations that would be obvious to one of ordinary skill in the art upon reading the present specification. Further, it is not intended that any section or subsection of this specification (i.e., the Summary, Detailed Description, Abstract, Field of the Invention, etc.) be accorded special significance in describing the inventions relative to another or the claims. Any of the teachings presented in one section, may be applied to and/or incorporated in another. The same holds true for the teaching of any of the related applications with respect to any section of the present disclosure. The related applications are:
Low Weight Reinforced Thermoplastic Composite Goods (US provisional application);
Reconfigured Thermoplastic Composite Constructs (US provisional application); Panel-Derived Thermoplastic Composite Components and Products (PCT application);
Thermoplastic Structures Designed for Welded Assembly (PCT application); and Hybrid Thermoplastic Composite Goods (PCT application),
   each to the assignee hereof and filed on even date herewith. Moreover, each and every one of these applications is incorporated by reference herein in its entirety for any and all purposes, as are all of the other references cited herein. Should any US published patent application or US patent claim priority to and include the teachings of one or more of the aforementioned US provisional applications, then that US published patent application and that US patent is likewise incorporated by reference herein to the extent it conveys those same teachings. The assignee reserves the right to amend this disclosure to recite those publications or patents by name. Although the foregoing inventions have been described in detail for purposes of clarity of understanding, it is contemplated that certain modifications may be practiced within the scope of the claims made.

1. A thermoplastic composite structure made according to a method of manufacture comprising:
shaping cutouts from at least partially consolidated thermoplastic composite material, at least some of the cutouts having a curvilinear planform shape and varying in size;
stacking the cutouts in a mold cavity to define layers making steps for an assembly;
heating the assembly to cause a matrix material in the thermoplastic composite material to flow and fill in the steps; and
cooling the assembly to produce a final structure.

2. The structure of claim 1, wherein the steps define a curved surface of the structure.

3. The structure of claim 2, wherein the curved surface is curved in two different directions.

4. The structure of claim 2, wherein opposite sides of the structure are both curved, with opposite convexity.

5. The structure of claim 1, wherein no layer has a periphery substantially overhanging another relative to a facing surface of a mold cavity, and the flow filled steps produce a substantially uniform surface exposed as an exterior surface of the structure upon mold cavity removal.

6. The structure of claim 1, where the flow filled steps define a substantially planar surface.

7. The structure of claim 6, wherein the method of manufacture further comprises:
bonding the substantially planar surface to a second substantially planar surface of a second, identically manufactured structure to produce a final piece.

8. The structure of claim 1, wherein at least an interior cutout defines a pocket receiving coring material.

9. A thermoplastic composite structure comprising:
a plurality of consolidated layers of thermoplastic composite material, each of the layers shaped to have a perimeter with at least one curvilinear portion; and
a webbing of a matrix material from the thermoplastic composite material forming a substantially uniform exterior surface between the layer perimeters.

10. The structure of claim 9, wherein the exterior surface is curved or substantially planar.

11. A composite structure production construct:
a mold body defining a mold cavity; and
a plurality of layers comprising thermoplastic composite material positioned within the mold cavity stacked upon one another in a stepped fashion;
the mold cavity and the layers together defining a tuned gap adapted to permit thermoplastic matrix material from the composite material to flow and span the steps when the composite material is heated.

12. The construct of claim 11, wherein at least some of the layers are held in alignment by at least one encapsulated member selected from pins and coring material.

13. The construct of claim 11, wherein the mold body further comprises gates for matrix outflow.

14. The construct of claim 11, wherein the plurality of layers include all of the matrix material required to flow and span the steps.

15. The construct of claim 11, further comprising at least one layer of thermoplastic matrix material with no reinforcement fibers set adjacent a surface of the mold.
